(19) United States
(12) Patent Application Publication
(10) Pub. No.: US 2024/0240987 A1
(43) Pub. Date: Jul. 18, 2024

(54) CLEAR, COLORED AND ADVANCED MARKERS DETECTABLE BY THERMAL SENSORS

(71) Applicant: Infrared Tools LLC, Crofton, MD (US)

(72) Inventors: Thomas BOYER, Gambrills, MD (US); Isabel Fleckenstein, Crofton, MD (US); Patrick May, Pasadena, MD (US)

(73) Assignee: Infrared Tools LLC, Crofton, MD (US)

(21) Appl. No.: 18/414,345

(22) Filed: Jan. 16, 2024

Related U.S. Application Data
(60) Provisional application No. 63/480,008, filed on Jan. 15, 2023.

(51) Int. Cl. G01J 5/02; G01J 5/00

(52) U.S. Cl. CPC G01J 5/02; G01J 2005/0077

(57) ABSTRACT

A thermal marker, according to various embodiment, can include a marker detectable by thermal sensors but having additional properties. The thermal marker can be developed in a panoply of colors or can be created to have retroreflective properties. In various embodiments, a single marker can be produced that is detectable by multiple thermal imaging sensor systems. In various embodiments, the markers can be simultaneously used with the naked eye and various sensors. Additionally, a method according to various embodiments can produce a thermal marker in a wide variety of colors. The thermal markers can covertly mark objects, such as vehicles, people, and other fixed assets efficiently to assist in surveillance missions.

### I. CROSS REFERENCE TO RELATED APPLICATIONS

This application claims benefit to U.S. Provisional Patent Application No. 63/480,008, filed Jan. 15, 2023, which is incorporated by reference herein in its entirety.

### II. TECHNICAL FIELD

The present disclosure relates generally to the field of thermal markers detectable by thermal sensors.

### III. BACKGROUND

Various users and industries have found utility in non-contact thermal sensors and cameras. For example, cooks can measure the temperature of frying pans. Law enforcement can more effectively search for lost persons. Hunters can shoot nocturnal predators in complete darkness. The military can engage targets in complete darkness. Manufacturing operations can effectively evaluate the quality of a process.

In many cases, there is utility in being able to mark a location within the field of view of a thermal camera. Generally, there are two methods of marking to identify an object by detecting infrared heat emanating from the surfaces of all the objects in a scene. The first method of marking is by placing hot or cold objects within the field of view such that the object is identifiable because the object's temperature is differentiated from most of the scene. The second method of marking is by placing objects with relatively low emissivity within the field of view such that the object is identifiable because the object's temperature appears to be differentiated from most of the scene even though the temperature is actually similar to that of the environment.

Some conventional markers have been created using low emissivity films such as those proposed by O'Keefe, which is described in EP 2764320. However, these conventional markers are effective but limited in application where the marker is preferred to be transparent for covertness or having additional functionality such as preferred color or retroreflection. Other conventional examples that suffer from this problem include, for example, by Yang, which is described in U.S. Pat. No. 6,030,671, by Gillery, which is described in U.S. Pat. No. 4,786,563, by Van Nutt, which is described in 9,097,842, and by Condo, which is described in WO2009085741. These conventional markers are opaque having a fixed color.

Thus, there is a need for a low-emissivity marker which is clear so that the marker is not visibly obvious on the object being marked. Additionally, there is a need for the ability to create markers in a panoply of colors which are aesthetically pleasing to users.

Furthermore, there is a need to combine into a single marker the ability to be detected by multiple sensor systems. In infrared thermography, the type of imaging cameras can be defined based on the specific wavelength range. Example imaging devices include Forward-looking Infrared (FLIR) cameras, Near Infrared (NIR) cameras, and Shortwave Infrared (SWIR) cameras. Unfortunately, one camera does not work for all three categories. NIR, SWIR, and FLIR energies depend on different technology to make them visible. Night Vision devices (NVD) see NIR. SWIR devices see SWIR and FLIR. Thermal devices view FLIR. The wavelength of infrared that thermal imaging cameras (FLIR) detect is 3 to 12 μm and differs significantly from that of night vision, which operates in the visible light and near-infrared ranges (0.4 to 1.0 μm).

### IV. SUMMARY

The embodiments featured herein help solve or mitigate the above noted deficiencies as well as other issues known in the art. The present disclosure, through one or more of its various aspects, embodiments, and/or specific features or sub-components, provides, inter alia, various systems, devices, and methods for producing clear, colored and advanced thermal markers detectable by thermal sensors.

Various embodiments relate to infrared film technology. Various embodiments discloses different types of thermal markers. For example, an embodiment relates to a clear thermal marker. Another embodiment relates to colored thermal markers. Further embodiments relate to retroreflective thermal markers.

Various embodiments pertain to a system and method of marking an object using low emissivity films and the process for producing markers made of low emissivity films.

In various embodiments, the present disclosure relates to a device and method of producing clear thermal markers that fulfill the need for clear and colored and fusion markers in a panoply of colors.

Various embodiments can provide a single marker that can be detected by multiple thermal imaging sensor systems.

A thermal marker according to various exemplary embodiments can include a covert target marker. The covert target marker can be configured to be invisible to the human eye when the covert target marker is attached to an object being marked but detectable by a thermal sensor. The covert target marker can include a first surface and a second surface. The first surface can be configured to attach to the object to be thermally and covertly marked. The second surface can be configured to have optical properties and to be transparent to visible light, low emissivity, and high reflectivity.

A thermal marker according to various exemplary embodiments can include a covert target marker. The covert target marker can be configured to be invisible to the human eye when the covert target marker is attached to an object being marked but detectable by a thermal sensor. The covert target marker can include a first film and a second film. The first film can include a first film first surface and a first film second surface. The first film first surface can be configured to attach to the object to be thermally and covertly marked. The first film second surface can be configured to have one or more optical properties and to have an image printed thereon comprising a colorant component that forms a colored region. The second film can include a second film first surface and a second film second surface. The second film first surface can be configured to attach to the first film second surface. The second film second surface can be configured to have a shape that matches the colored region of the first film second surface and configured to be transparent to visible light, low emissivity, and high reflectivity.

A laminated marker according to various exemplary embodiments can include a covert target marker. The laminated marker can include a base film, a middle film, and a top film. The base film can be configured to have predetermined optical properties. The middle film can be configured to provide durability and protection. The top film can be configured to have at least 50% visibly transparent and having an emissivity less than or equal to 50% and which is detectable by a thermal sensor.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### V. BRIEF DESCRIPTION OF THE DRAWINGS

The skilled artisan will understand that the drawings described below are for illustrative purposes only. The drawings are not intended to limit the scope of the present teachings in any way.

FIG. 1 is an illustration of a range of the electromagnetic spectrum that an exemplary marker is operable according to the present teachings.

FIG. 2 is a side view of various layers of an exemplary marker rendered as a coating for covering an object according to the present teachings.

FIG. 3 is an embodiment of a clear thermal marker according to the present teachings.

FIG. 4 shows an embodiment of a clear thermal marker in the representative form spelling the word “SUSPECT” according to the present teachings.

FIG. 5 shows the clear thermal marker of FIG. 4 applied to a vehicle such that the clear thermal marker is invisible to the naked eye according to the present teachings.

FIG. 6 shows the clear thermal marker of FIG. 4 applied to the vehicle and is visible through the use of a thermal imaging device according to the present teachings.

FIG. 7 is an illustration of an exemplary marker detectable by thermal sensors according to the present teachings.

FIG. 8 is a flow chart diagram illustrating one embodiment of a method of manufacturing an exemplary marker detectable by thermal sensors according to the present teachings.

### VI. DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

The specific devices and assemblies illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Certain recitations contained herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Further, in this document, relational terms, such as first and second, top and bottom, and the like, are used solely to distinguish one entity or action from another entity or action, without necessarily requiring or implying any actual such relationship or order between such entities or actions.

Various embodiments relate to infrared film technology. Various embodiments discloses different types of thermal markers. For example, an embodiment relates to a clear thermal marker. Another embodiment relates to colored thermal markers. Further embodiments relate to retroreflective thermal markers.

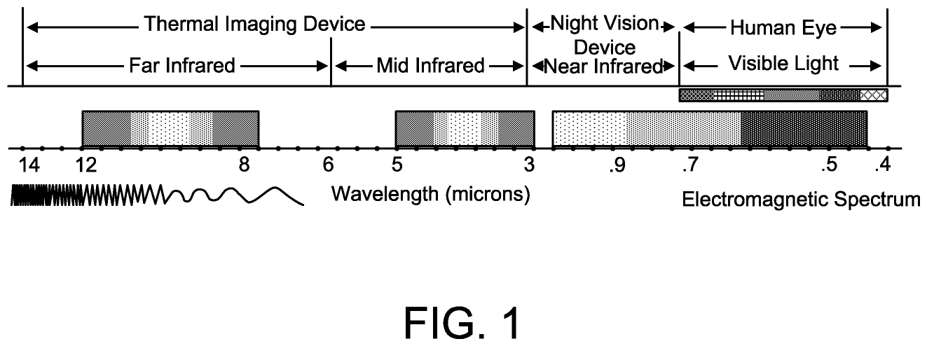

All of the films of the thermal markers disclosed herein relate to identification products that employ the principles of electromagnetic spectrum. As shown in FIG. 1, Near, Mid, and Far Infrared (IR) are all part of the electromagnetic spectrum, which describes the entire range of energy that exists. Most energy is invisible to the naked eye. Hi-tech cameras are used to make invisible energy appears visible. Near infrared (NIR) can be seen with a Night Vision device (NVG). And Mid and Far IR can only be seen with a thermal imaging device.

The system and method disclosed herein provides a marker visible to sensors sensitive to various wavelengths of energy including some or all of visible, near infrared, mid wave infrared, and long wave infrared, as shown in FIG. 1. Various embodiments can provide a single marker that can be detected by multiple thermal imaging sensor systems. For example, some users may require a marker which is detected by thermal sensors and reflective for night vision or visible sensors.

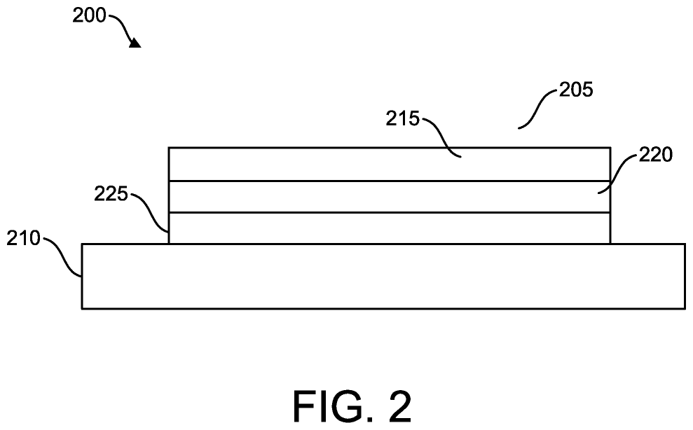

Various embodiments relate generally to the field of infrared protection including systems and devices for those seeking identification of friend or foe (IFF) protection. As illustrated in FIGS. 2-6, an IFF system or method as described herein can covertly identify an object as a friend or foe. The application of a thermal film marker attached to an object provides critical information needed to successfully identify objects within a scene. In FIG. 2, the IFF system 200 comprises at least one thermal marker 205 used to covertly mark an object 210, for example, a vehicle, people, animals, fixed assets, landscape, other objects or a combination thereof.

In FIG. 2, the thermal marker 205 is generally shown as a film that may be applied to a surface of an object 210. At the most basic level, the thermal marker 205 can include a thermal layer that is reflective to thermal energy and one or more additional layers. In the example of FIG. 2, the thermal marker 205 can be fabricated from three different layers of material, which can include a top layer 215, a middle layer 220, and a base layer 225. The top layer 215 can be visibly transparent and reflective to thermal energy. The middle layer 220 can have certain optical properties that meet predetermined specifications as defined by the user. The base layer 225 can adhere to the object 210 being marked. All three layers can be bonded or coupled together. The top layer 215, the middle layer 220, and the base layer 225 may be combined through sequential coating or printing of each layer, sequential lamination or embossing, or any other suitable process.

The thermal marker 205, according to various embodiment, can include a marker detectable by thermal sensors but have additional properties. Typical thermal decals are only detectable by thermal sensors and are available in a limited number of colors. According to the present teachings, the thermal marker 205 can be developed in a panoply of colors or can be created to have retroreflective properties. In this way, in some embodiments, the markers can be simultaneously used with the naked eye and various sensors. Additionally, for aesthetic reasons, the thermal marker 205 can be produced in a panoply of colors, because some users desire colors other than the colors currently available in the art. Often law enforcement and the military may utilize thermal sensors in combination with other sensors in order to provide logistics and command and control during operations. The ability to covertly mark vehicles, people, other fixed assets, and other objects efficiently aids law enforcement in their mission.

The thermal marker 205 can be produced in a panoply of colors, because the marker 205 can include a film which is both visibly clear and thermally reflective, which enables the usage of a standard digital printing techniques that can create infinite colors. In contrast, the color of conventional markers was typically developed in batches and special pigments were needed to create the color while not blocking the infrared. For conventional markers, this limited the available color palette and increased the batch size.

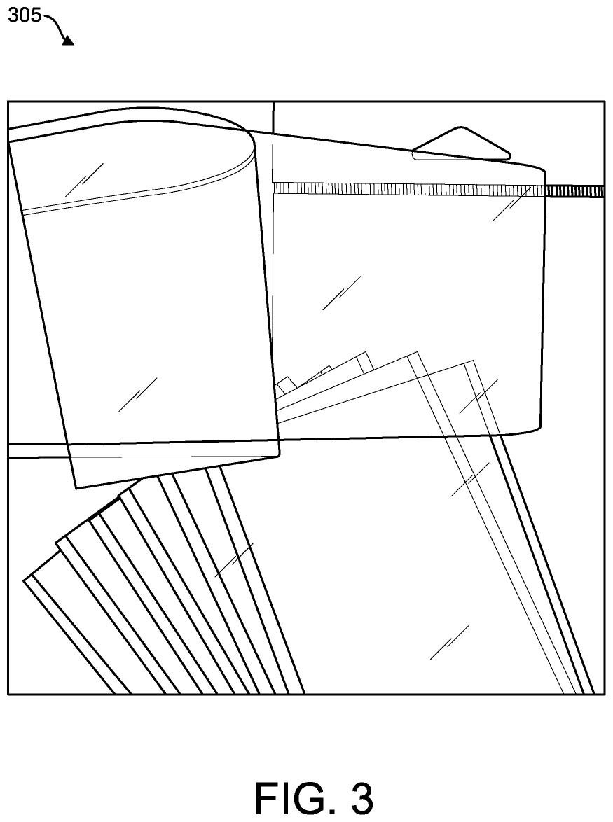

In a clear thermal marker embodiment, as shown in FIG. 3, the clear appearance of the thermal marker 305 prevents naked eye detection. In other words, when applied to an object, the thermal marker 305 is clear and undetectable by the naked eye such that the thermal marker 305 is transparent through which the underlying object is visible. In use, the clear thermal marker 305 is visible with the use of a thermal device.

In order to produce clear thermal markers, these thermal marker films can be converted into products such as:
Sheets which can be directly applied or cut to shape
Rolled strips which can be directly applied or cut to shape
Precut shapes such as letters, numbers, and geometric shapes which can be directly applied to an object.

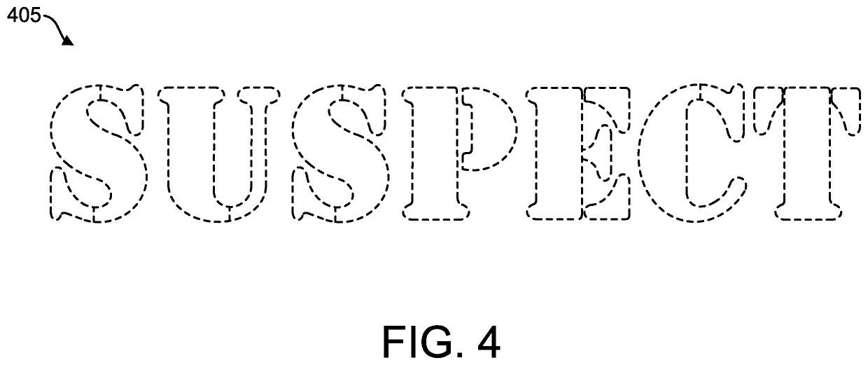

As depicted in FIGS. 4-6, the clear thermal marker is best suited for dangerous covert undercover operations. For example, law enforcement authorities often have a need to covertly and thermally mark vehicles. A thermal marker or patch can be used to identify a police officer from a criminal suspect. FIGS. 4-6 show an example of marking a suspect vehicle to covertly track the vehicle's movement.

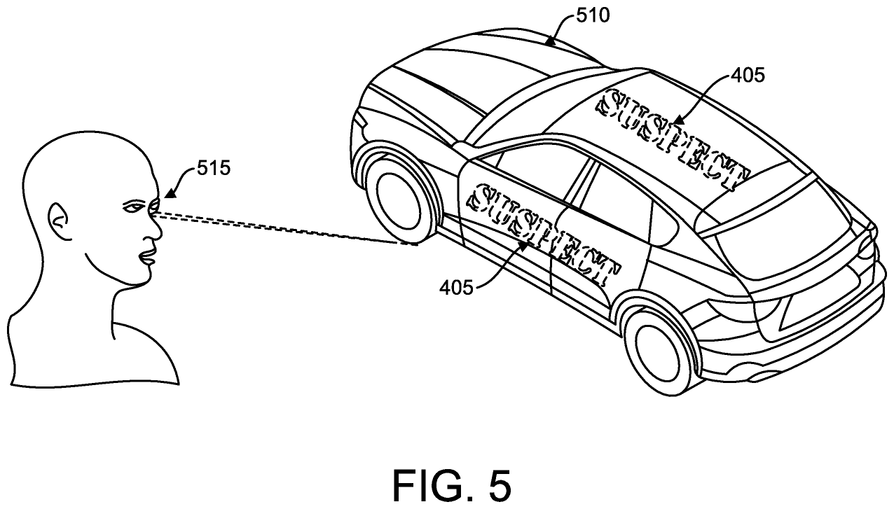

In FIG. 4, a clear thermal marker 405 can be designed to have the shape and form the word “SUSPECT”. In FIG. 5, when the clear thermal marker 405, which is shown as the word “SUSPECT” in broken lines, is attached to a vehicle 510, the clear thermal marker 405 can be difficult to see with the naked eye 515. Thus, the vehicle 510 can be marked and the marking rendered undetectable by the naked eye 515.

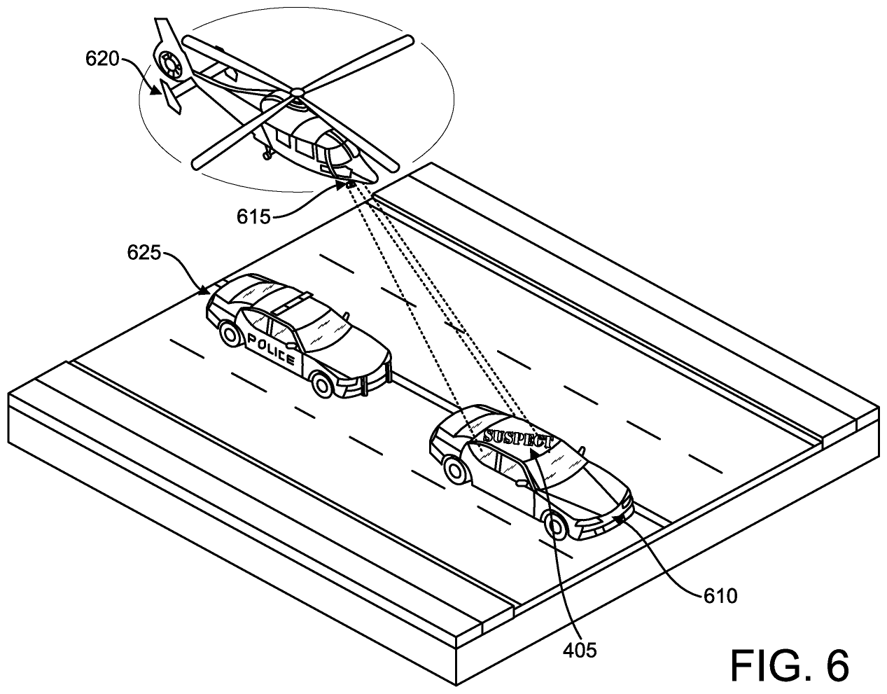

In FIG. 6, when in use with a thermal imaging device 615, the clear thermal marker 405 is visible to identify the suspect's vehicle from other objects within the scene. The suspect's vehicle 610 or undercover vehicles can be effectively and covertly marked so that overhead surveillance by thermal camera equipped drones, helicopters, and airplanes can distinguish the marked vehicle from others in the scene. As illustrated in the example of FIG. 6, law enforcement authorities 620, 625 may desire to mark a civilian vehicle 610 with the clear thermal marker 405 as a suspect without the owner's knowledge to effectively distinguish the marked vehicle 610 from others when using overhead surveillance by thermal camera 615 equipped aircrafts 620, such as helicopters, airplanes, and drones.

In an embodiment, the clear thermal marker includes a film which is both visibly clear and thermally reflective. Examples of such a film are 3 M® Thinsulate® Prestige 75 and St Gobain Ecolux® 75, which can be included in the novel process of manufacturing the thermal marker described herein. The film includes a first surface (bottom) and a second surface (top). The first surface has a pressure sensitive adhesive which can effectively bond the film to the object to be thermally and covertly marked. However, those familiar with the art will recognize other methods of attaching the base film to the surface of the object. The second surface has the characteristic of having a low emissivity and high reflectivity. Preferably, the emissivity is less than 50%, and most preferably the emissivity is less than 20%. The film and its surfaces together are very transparent to visible light. Preferably, the light transparency is greater than 50%, and most preferably the light transparency is 75% or more.

In a colored thermal marker embodiment, thermal markers in a panoply of colors may be made by laminating two films. The base film may include a first surface and a second surface. In the preferred embodiment, a pressure sensitive adhesive may be applied to the first surface which can affectively bond the base film to the surface of the object to be marked. However, those familiar with the art will recognize other methods of attaching the base film to the surface of the object can be employed. In the preferred embodiment, a color and/or geometry matching the desired thermal marker can be applied to the surface of the base film with a digital printing method. Alternatively, other means of developing color on the second surface including other printing methods and the application of colored films can be employed. In the most preferred embodiment, the base film may be vinyl, however, in other embodiments, many different types of film might be used. The second film, generally referred to as the top film may include a first and a second surface. The first surface may include an optically clear pressure sensitive film applied thereon to adhere effectively to the second surface of the base film. Moreover, other methods may also be used to attach the base film to the surface of the base film. The second surface may have a low emissivity, preferably less than 50%, and most preferably less than 30%. In the preferred embodiment, the top film may include, for example, 3 M® Prestige 75 or St Gobain Ecolux® 75, however, those familiar with the art will recognize that any visibly clear film with low emissivity can be used. The top film may be cut to the same shape as the colored region on the second surface of the base film. The color is visible through the visibly clear film presenting the user a marker which is both detectable by thermal sensors and having a color which is aesthetically pleasing.

In some embodiments, a retroreflective thermal marker can be made to be both retro reflective to one or more of visible energy (0.3 to 0.7 μm) and near infrared (0.7 to 1.5 μm) energy, and visible to thermal sensors. The retroreflective thermal marker may include two films, a base film and a top film. The base film may include a first surface and a second surface. The first surface can be coated with a pressure sensitive adhesive which bonds effectively to the surface of the object being marked. In some embodiments, other methods of attaching the base film to the surface of the object may be employed. The second surface may be retroreflective to visible energy and/or near infrared energy. The second surface may also be a preferred color or it may be the natural color of the retroreflective film which is often a shade of gray. In the preferred embodiment, the base film may be cut into the shape of a letter, number, or geometric shape. In the first alternate, the base film may not be cut, but instead a portion of the base film may be obscured by covering it with an opaque ink or film. The top film may include a first and second surface. In the preferred embodiment, the first surface may be coated with an optically clear pressure sensitive adhesive which affectively adheres to the second surface of the base film. However, those familiar with the art will know that various other means can be used to bond the top film to the bottom film including other adhesive types and welding. The top film may be cut to match the letter, number, or geometric shape developed using the base film. The top film may then be adhered to the base film. The result is a marker visible to sensors sensitive to various wavelengths of energy including some or all of visible, near infrared, mid wave infrared, and long wave infrared.

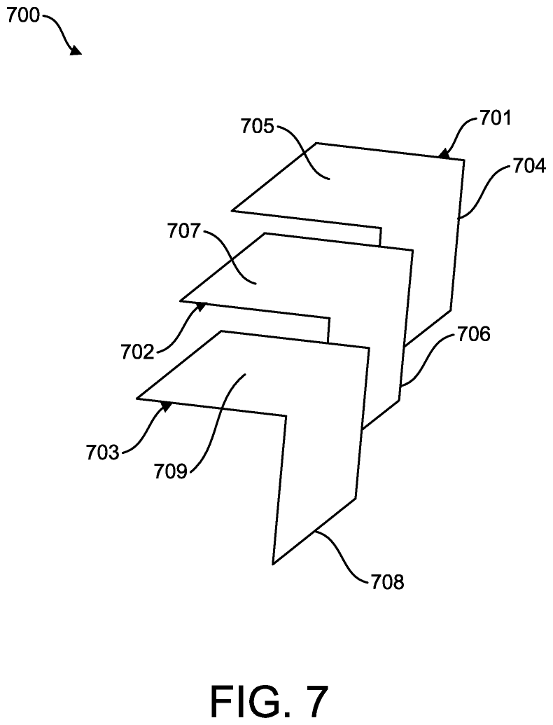

In various embodiments as shown in FIG. 7, the thermal marker can include a base film (701), a middle film (702), and a top film (703). The base film (701) can include a first surface (704) and a second surface (705). The middle film can include a first surface (706) and a second surface (707) whose purpose is to protect the base film (701). The top film (703) which is visibly transparent and reflective to thermal energy can include a first surface (708) and a second surface (709).

In FIG. 7, the first surface (704) of the base film (701) (bottom) can adhere to an object being marked. The second surface (705) of the base film (701) (top) can have certain optical properties advantageous to the user. The first surface (706) of the middle film (702) (bottom) can adhere to the second surface (705) of the base film (701). The second surface (707) of the middle film (702) (top) can provide a protective wear surface. The first surface (708) of the top film (703) (bottom) can adhere to the second surface (707) of the middle film (702) or to the object being marked if the bottom film (701) and middle film (702) are excluded. The second surface (709) of the top film (703) (top) can be very low in emissivity in order to reflect thermal energy.

In the most preferred embodiment, a top film (703) can be applied to a middle (702) and base film (701). The base (701) most preferably can consist of white graphic vinyl made for vehicles and has excellent durability when exposed to the environment. The base film (701) may include a first (704) and second surface (705). The first surface (704) may include a pressure sensitive adhesive which adheres effectively to the surface of the object being marked. The second surface (705) may be printable using a digital printer or other print process. An image consisting of numbers, letters, or geometric shapes may be developed on the second surface (705). It should be understood that the base film (701) may be larger than the top film (703) or it may be cut to have the exact geometry of the top film (703). Preferably, the bottom film (701) may be no smaller than the top film (703). Preferably, but optionally, a middle film (702) may be laminated to the base film (701) such that the first surface (706) of the middle film (702) may be fully adhered to the second surface (705) of the base film (701) to protect the base film (701). Preferably, the middle film (702) may be a visibly transparent urethane film having a life span of more than 5 years. The top film (703), most preferably, may consist of, for example, St. Gobain Ecolux® 75 which is a visibly transparent, thermally reflective, low emissivity film. Preferably the top film (703) may be a polyester (PET) film having various layers deposited thereon which creates the required properties. The top film (703) may be cut to match the geometry of the image developed on the base film (701). The cutting is most preferably performed using a computer numerically controlled knife cutter. However, the cutting can be performed with many different cutting technologies such as a laser cutter, or manually with scissors. After cutting, the top film (703) can then be laminated to the middle film (702) directly on top of the image developed on the base film (701) such that the bottom surface (708) of the top film (703) is fully adhered to the second surface (707) of the middle film (702). In this embodiment, the second surface (709) of the top film (701) can be detectable by thermal sensors and have a color desirable to the user.

A first alternate embodiment replaces the base film with a retro-reflective film. In the first alternate, embodiment a top film (703) can be applied to a middle (702) and base film (701). The base film (701) most preferably can consist of a retroreflective film made for vehicles and has excellent durability properties when exposed to the environment. The base film (701) may include a first (704) and second surface (705). The first surface (704) may include a pressure sensitive adhesive which adheres effectively to the surface of the object being marked. The second surface (705) may be retroreflective to one or more of visible energy (0.3 to 0.7 μm) and near infrared energy (0.7 to 1.5 μm). It should be understood that the base film (701) may be larger than the top film (703) or it can be cut to have the exact geometry of the top film (703). Preferably, the bottom film (701) may be no smaller than the top film (703). Preferably, but optionally, a middle film (702) may be laminated to the base film (701) such that the first surface (706) of the middle film (702) is fully adhered to the second surface (705) of the base film (701) to protect the base film (701). Preferably, the middle film (702) can be a visibly transparent urethane film having a life span of more than 5 years. The top film (703), most preferably, may consist of, for example, St. Gobain Ecolux® 75 which is a visibly transparent, thermally reflective, low emissivity film. Preferably, the top film (703) may be a polyester (PET) film having various layers deposited on which create the required properties. The top film (703) may be cut to match the geometry of the image developed on the base film (701). The cutting may be, most preferably, performed using a computer numerically controlled knife cutter. However, the cutting can be performed with many different cutting technologies such as a laser cutter, or manually with scissors. After cutting, the top film (703) may then be laminated to the middle film (702) directly on top of the image developed on the base film (701) such that the bottom surface (708) of the top film (703) is fully adhered to the second surface (707) of the middle film (702). In this embodiment, the second surface (709) of the top film (701) can be detectable by thermal sensors and can be retroreflective to visible energy and/or near infrared energy causing the marker to also be detectable by the naked eye and/or night vision devices (NVDs).

A second alternate embodiment may be produced without the base (701) and middle films (702) entirely; thus, placing the top film (703) directly on to the surface of the object being marked. The top film (703), most preferably, may consist of, for example, St. Gobain Ecolux® 75 which is a visibly transparent, thermally reflective, low emissivity film. Preferably, the top film (703) may be a polyester (PET) film having various layers deposited thereon which creates the required properties. The top film (703) may be cut to match the geometry of the desired image such as a letter, number, or geometric shape such as a chevron as depicted in FIG. 7. The cutting may be most preferably performed using a computer numerically controlled knife cutter. However, the cutting can also be performed with many different cutting technologies such as a laser cutter, or manually with scissors. The first surface (708) of the top film (703) may be adhered directly onto the object being marked. In this embodiment, the region where the top film (703) is located can be detectable by thermal sensors and the color of the object being marked can be visible through the top film (703). The result is a marker which can be readily detectable by thermal sensors but difficult to notice with the naked eye.

### Example 1

A section of white vinyl 36″×24″ was printed to form the numbers 123 in orange and the background was printed in olive drab green. A piece of urethane protective film, also 36″×24″ was laminated over the entire surface of the vinyl. The St Gobain Ecolux® 75 was cut with a CNC knife to have the same shape as the numbers 123. The release liner was removed from the St Gobain Ecolux® 75 and then laminated directly over the numbers 123. The result was a large decal having orange numbers 123 which were detectable by thermal sensors.

### Example 2

A section of yellow retroreflective film 36′ λ 24″ was printed blue as a background only leaving a section (the foreground) in yellow in the shape of the numbers 123. A piece of urethane protective film, also 36″×24″ was laminated over the entire surface of the vinyl. The St Gobain Ecolux® 75 was cut with a CNC knife to have the same shape as the numbers 123. The release liner was removed from the St Gobain Ecolux® 75 and then laminated directly over the numbers 123. The result was a large decal having yellow numbers 123 which were simultaneously yellow retroreflective and detectable by thermal sensors.

### Example 3

A section of St Gobain Ecolux® 75 was cut into the shape of a chevron 12″×12″. The marker was attached to the roof of a red truck using the water and squeegee method of application. The result was a decal which was visibly covert and detectable by thermal sensors.

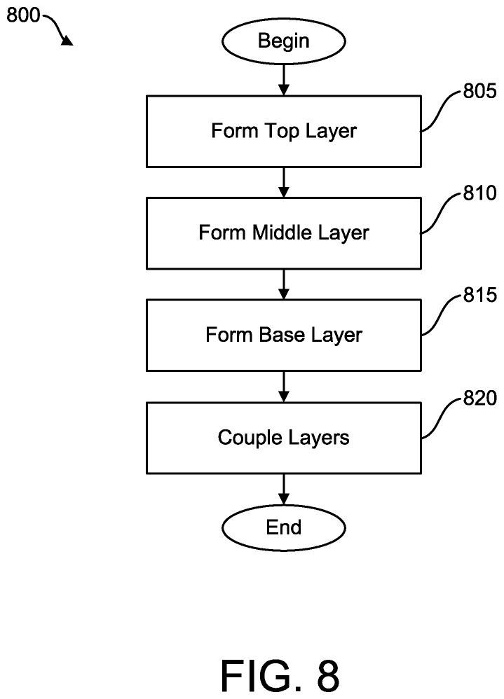

FIG. 8 depicts one embodiment of a method 800 of manufacturing an exemplary thermal marker 205 which is detectable by a thermal sensor. As used herein, a manufacturer may include one or more of a manufacturing hardware machine of other device, a robotic device, a factory device, a hardware and/or software controller for such a device, a user and/or administrator of such a device, or the like.

The method 800 begins and a manufacturer forms 805 a top layer 215 (e.g., using a stamp process, an injection molding process, a form/casting process, a cutting process, or the like) such that the top layer 215 is visibly transparent and reflective to thermal energy. A manufacturer forms 810 a middle layer 220 (e.g., using a stamp process, a cutting process, a rolling process, or the like) such that the middle layer includes certain optical properties that meet predetermined specifications as defined by a user. A manufacturer forms 815 a base layer 225 (e.g., using a stamp process, a cutting process, a rolling process, or the like) such that the base layer 225 adheres to an object being marked. A manufacturer bonds 820 the top layer 215, the middle layer 220 and the base layer 225 in a layered stacked configuration, using an adhesive or the like, and the method 800 ends.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A thermal marker, comprising:
a covert target marker configured to be invisible to the human eye when the covert target marker is attached to an object being marked but detectable by a thermal sensor,
wherein the covert target marker comprises:
a first surface configured to attach to the object to be thermally and covertly marked; and
a second surface configured having optical properties and to be transparent to visible light, low emissivity, and high reflectivity.

2. The thermal marker of claim 1, wherein the second surface has a low emissivity less than 50%.

3. The thermal marker of claim 1, wherein the second surface has a transparency greater than 50%.

4. The thermal marker of claim 1, wherein the second surface has a low emissivity less than 50% and a transparency greater than 50%.

5. The thermal marker of claim 1, wherein the covert target marker has a clear color such that a surface color of the object being marked is visible through the first surface and the second surface of the covert target marker.

6. The thermal marker of claim 1, wherein the second surface comprises a polyester (PET) film having multiple layers.

7. The thermal marker of claim 1, wherein the first surface includes a first film,
the first film comprises:
a first film first surface configured to attach to the object to be thermally and covertly marked; and
a first film second surface having one or more optical properties and having an image printed thereon comprising a colorant component that forms a colored region; and
wherein the second surface includes a second film,
the second film comprises:
a second film first surface configured to attach to the first film second surface; and
a second film second surface configured having a shape that matches the colored region of the first film second surface and configured to be transparent to visible light, low emissivity, and high reflectivity.

8. The thermal marker of claim 7, wherein the second film has a clear color such that the colored region is visible and detectable by the thermal sensor.

9. The thermal marker of claim 8, further comprising:
a protective film interposed between the first film and the second film; and
a laminate affixed over surfaces of the first film, the protective film, and the second film to produce a laminated marker structure.

10. The thermal marker of claim 9, wherein the second surface has a low emissivity less than 50% and a transparency greater than 50%.

11. The thermal marker of claim 7, wherein the first film second surface comprises a vinyl surface.

12. A thermal marker, comprising:
a target marker configured to be detectable by a thermal sensor,
wherein the target marker comprises:
a first film comprising:
a first film first surface configured to attach to the object to be thermally marked; and
a first film second surface comprises a retroreflective film; and
a second film comprising;
a second film first surface configured to attach to the first film second surface; and
a second film second surface configured to be retroreflective as a result of the retroreflective film such that the target marker retroreflects visible energy and near infrared energy to be detectable by the human eye and a night vision device.

13. The thermal marker of claim 12, wherein the target marker is further configured to be visible to the thermal sensor that is sensitive when exposed to different wavelengths of at least one of visible, near infrared, mid-wave infrared and long wave infrared.

14. The thermal marker of claim 12, wherein the visible energy is in a range from about 0.3 micron to about 0.7 micron and the near infrared energy is in a range from about 0.7 micron to about 1.5 micron.

15. A laminated marker comprising:
a base film configured to have predetermined optical properties;
a middle film configured to provide durability and protection; and
a top film configured to have at least 50% visibly transparent and having an emissivity less than or equal to 50% and which is detectable by a thermal sensor.

16. The laminated marker of claim 15, wherein the base film comprises a colorant component printed thereon.

17. The laminated marker of claim 15, wherein the base film is a retroreflective film such that the laminated marker retroreflects visible energy and near infrared energy to be detectable by at least one of a naked eye and night vision devices.
